(19) United States
(12) Patent Application Publication
(10) Pub. No.: US 2004/0120859 A1
(43) Pub. Date: Jun. 24, 2004

(54) Biomolecular micro-deposition system

(76) Inventors: Thomas E. Kocher, Rochester, NY (US); Timothy J. Wojcik, Rochester, NY (US)

Correspondence Address: Thomas H. Close, Patent Legal Staff, Eastman Kodak Company, 343 State Street, Rochester, NY, 14650-2201, US

(21) Appl. No.: 10/326,759

(22) Filed: Dec. 20, 2002

(51) Int. Cl. B01L 3/02

(52) U.S. Cl. 422/100

(57) ABSTRACT

A system for depositing molecular liquids on a receiver comprising: a printing station having one or more print heads spanning the width of a receiver to be printed on; a receiver transport mechanism for transporting a receiver through the printing station so that the one or more print heads can deposit molecular liquids in an array on the receiver; a maintenance and service station located in proximity to the printing station; and a printhead translation mechanism for moving a printhead to the maintenance and service station to receive maintenance and service.

### FIELD OF THE INVENTION

This invention relates in general to molecular biological systems and, more particularly to a means by which micro-array receivers of molecular biological reagents and samples can be produced. More particularly, the invention provides a means by which small volumes of molecular biological liquids can be deposited onto rigid, semi-rigid or flexible supports for the production of micro-array receivers.

### BACKGROUND OF THE INVENTION

As is well known (and described for example in U.S. Pat. No. 5,807,522, inventors Brown et al. and in “DNA Microarrays: A Practical Approach”, Schena, Mark, New York, Oxford University Press, 1999, ISBN 0-19-963776-8), micro-arrays are arrays of very small samples of purified DNA or protein target material arranged as a grid of hundreds or thousands of small spots on a substrate. When the micro-array is exposed to selected probe material, the probe material selectively binds to the target spots only where complementary bonding sites occur, through a process called hybridization. Subsequent quantitative scanning in a fluorescent micro-array scanner may be used to produce a pixel map of fluorescent intensities (See, e.g., U.S. Pat. No. 5,895,915, inventors DeWeerd et al.). This fluorescent intensity map can then be analyzed by special purpose algorithms that reveal the relative concentrations of the fluorescent probes and hence the level of gene expression, protein concentration, etc., present in the cells from which the probe samples were extracted.

Historically, microarrays could be constructed either manually or mechanically through the use of photolithographic, robotically controlled or other apparatus for the precise metering and placement of molecules. Alternatively, microarrays could be constructed through direct chemical synthesis on a solid support. Such devices and methods have the undesirable result that micro-arrays with a great number of individual spots and thus a great number of individual molecular biological reagents are contained with little or no means to identify them uniquely, either by human observations or machine.

Many examples exist for dispensing liquids in small volumes in the range of milliliters to sub-fractions of milliliters. For example, Pastinen et al. (Genorne Research, 7-606-614 (1997)) create an array of oligonucleotides by manually applying 0.5˜IL of a solution of 5′-amino-modified oligonucleotides onto an epoxide-activated glass slide to produce a 3×3 array of oligonucleotides on a 0.36 cm˜ area of a preprinted glass slide.

Other, more traditional printing methods have been used to create patterns of a few different reagents on a solid support. Means such as silk screening, offset printing, and rotogravure printing have been used in the production of reagent test strips. In such methods, each reagent ink is applied separately. Johnson, for example, (U.S. Pat. No. 4,216,245) discusses methods for the production of reagent test strip devices.

Pipette dispensing of reagents can be automated. Automation potentially increases the speed and accuracy of array production, while decreasing the necessary spacing between array positions. However, the utility of automated pipetting methods are severely limited in the number of different reagents that may be simultaneously applied (low parallelism). Cozzette et al., for example, (U.S. Pat. No. 5,554,339) discusses the use of microsyringes for dispensing reagents during the production of bio-sensor devices.

High-speed robotics have also been used to print micro-arrays of amino-modified cDNA molecules onto silylated glass microscope slides (CEL Associates, Houston) or poly-l-lysine coated microscope slides (Schena, BioEssays, 18:427-431 (1996); Schena et al., Proc. Nati. Acad. Sci., U.S.A., 93:10614-10619 (1996).

Another approach to microarray printing is an adaptation of inkjetting technology. For example, Hayes et al., U.S. Pat. No. 4,877,745 discusses an ink-jet type method and apparatus for dispensing reagents, particularly in the production of reagent test strips.

Pin transfer is one approach that allows the simultaneous transfer of greater numbers of samples than possible with the above approaches. Examples of such pins are discussed in U.S. Pat. No. 5,770,151, inventors Roach et al. and U.S. Pat. No. 5,807,522, inventors Brown et al.

Pirrung et al., U.S. Pat. No. 5,143,854, Fodor et al., U.S. Pat. No. 5,510,270, inventors, Fodor et al., U.S. Pat. No. 5,445,934, and Chee et al., International Patent Application, WO 95/11995 discuss the production of high 2 density oligonucleotide arrays through a photolithographic, directly onto a derivatized glass substrate.

McGall et al., U.S. Pat. No. 5,412,087 discusses a method for the production of a high density oligonucleotide array from pre-sythesized oligonucleotides.

Birch et al, U.S. Pat. No. 6,051,190 and U.S. Pat. No. 6,303,387 discusses a transfer rod for distribution of small amounts of liquid in biological or chemical analysis.

Bryning et al, U.S. Pat. No. 6,296,702 BI discusses an oscillating fiber apparatus for dispensing small volumes of a selected liquid onto a substrate. Similarly, Dannoux et al, International Patent Application WO 00/30754 discusses a method and apparatus for printing high-density biological arrays utilizing a plurality of rods housed with a channel.

Capillary transfer is another approach that allows the simultaneous transfer of greater numbers of samples. Chen et al, US Patent Application Publication No. 2001/0053334 discusses a print system and method of printing probe micro-arrays with capillary bundles. Similarly, Rogers et al., WO 00/01859 discusses a gene pen apparatus for repetitive printing of arrays.

In view of the above, the need is apparent for an efficient system for depositing molecular biological reagents and samples that are contained on solid or semi-solid or flexible supports.

### SUMMARY OF THE INVENTION

According to the present invention, there is provided a solution to the problems discussed above.

According to a feature of the present invention, there is provided a system for depositing molecular liquids on a receiver comprising:

a printing station having one or more print heads spanning the width of a receiver to be printed on;

a receiver transport mechanism for transporting a receiver through said printing station so that said one or more print heads can deposit molecular liquids in an array on said receiver;

a maintenance and service station located in proximity to said printing station; and

a printhead translation mechanism for moving a printhead to said maintenance and service station to receive maintenance and service.

### ADVANTAGEOUS EFFECT OF THE INVENTION

The invention has the following advantages.

1. Improved systems productivity is provided for the high speed production of microarrays of biological and chemical molecules on a rigid, semi-rigid or flexible supports.

2. A system is provided for depositing a large number of unique small volumes of molecular biological and chemical liquids on a substrate.

3. A system is provided wherein printheads can be easily removed, maintained and serviced.

### BRIEF DESCRIPTION OF THE DRAWINGS

FIG. 1 is a diagrammatic view showing the micro-deposition system for biomolecular fluids, including the printing and maintenance and service regions.

FIG. 2 is a diagrammatic view showing the “Net-shaped printhead with fluid connections and ejectors fluidically coupled to the supply lines.

FIG. 3 diagrammatically shows the elements contained in the maintenance and service region.

FIG. 4 diagrammatically shows the printhead engaged with a maintenance element.

FIG. 5 diagrammatically shows the relative movement of the printhead and the maintenance element including a compliant member that keeps the maintenance element in intimate contact with the printhead.

FIG. 6 diagrammatically shows a maintenance element with vacuum to pull fluids into the printhead assembly and to provide service of the printhead by vacuum assistance. A recessed area is included to provide a region for the vacuumed fluid to reside away from the printhead surface.

FIG. 7 diagrammatically shows a maintenance element in which an absorbing material is included.

FIG. 8 diagrammatically shows a maintenance element wherein a wiper blade is incorporated.

FIG. 9 diagrammatically shows a patterned array and magnification of a sub-region of the array created by the invention.

FIG. 10 diagrammatically shows a detailed view of the sub-region of the patterned array shown in FIG. 9.

FIG. 11 diagrammatically shows a detailed view of the array as shown in FIG. 9.

FIG. 12 diagrammatically shows a detailed view of a droplet ejected from the printhead to create the sub-array.

FIG. 13 diagrammatically shows a detailed view of a macro droplet ejected from the printhead of sufficient fluid volume to cover the entire region of the sub-array.

FIG. 14 is a diagrammatic view showing a “Net Shaped” piezoelectric material with cylindrical void.

FIG. 15 is a diagrammatic view showing an electrode configuration for the “Net Shaped” material of FIG. 14.

FIG. 16 is a diagrammatic view showing a simple print head configuration with a glass capillary tube inserted into the void and a fluidic connection.

FIG. 17 is a diagrammatic view showing a print head configuration of FIG. 3 with an orifice plate attached to the glass capillaries.

FIG. 18 is a diagrammatic view showing a print head configuration of a linear array of capillary tubes.

FIG. 19 is a diagrammatic view showing a print head configuration of a matrix of capillary tubes.

FIG. 20 is a diagrammatic view of a print head configuration where the voids created by the “Net shaped” process is the channel for molecular biological liquids.

### DETAILED DESCRIPTION OF THE INVENTION

In general, this invention relates to a system using a print head devices for micro-deposition of molecular biological or chemical liquids on a solid or semi-solid or flexible support. Approximately 1000 molecular biological liquids need to be uniquely placed on a 2-D grid, each solution occupying approximately 50-500 micro meter (um) diameter spot and preferably 50-200 um spot diameter. This invention is advantaged in that it provides an efficient means by which a large number of small volume molecular biological reagents can be deposited.

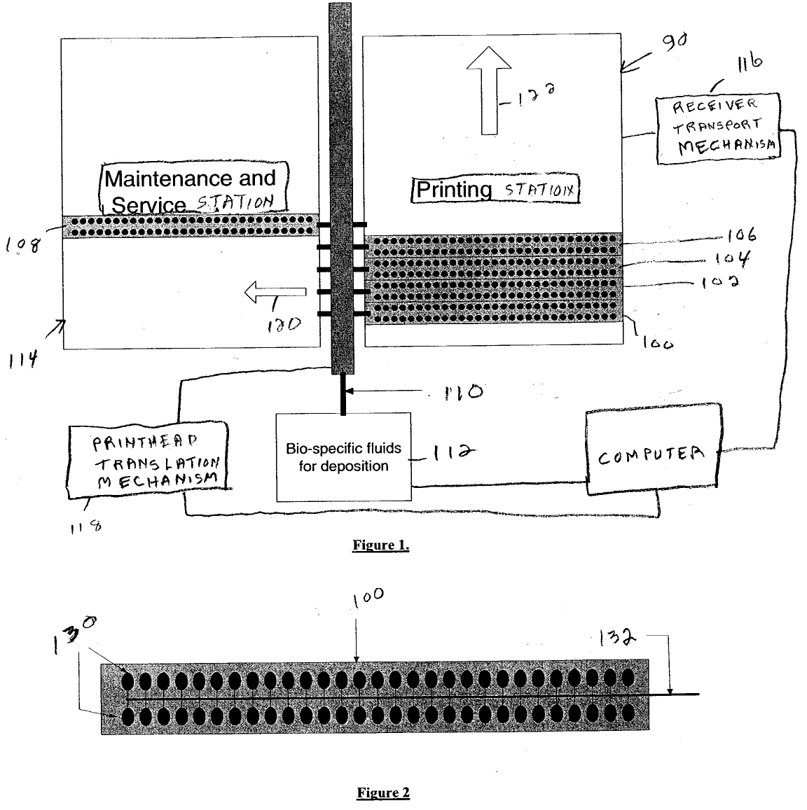

In the following description, a preferred print head will be described with reference to FIGS. 14-20, and then a system utilizing a plurality of such printheads will be described with reference to FIGS. 1-13.

Specifically, a print head is proposed where the deposition process is created by a pressure pulse derived from a piezoelectric element. This element is constructed by a process know as “net shaping” as discussed in Chatterjee et al., U.S. Pat. Nos. 6,065,195 and 6,168,746. This process provides the advantage of producing complex 3-D (three-dimensional) mechanical shapes with reduced manufacturing steps. As discussed in U.S. Pat. No. 6,168,746, this process consists of the steps: spray drying fine particulate ceramic ferroelectric material to form agglomerate material; mixing the spray dried fine particulate ceramic ferroelectric agglomerate material with a binder system including materials selected from the group consisting of wax having wax components of different molecular weight, magnesium-X silicate, agaroid gel forming material, and agaroid gel forming material mixed with magnesium-X silicate to form a compounded material; injecting the compounded material at a selected pressure into a mold to form a green article; debinding or drying the green article; sintering the debinded or dried green article to form the final molded article; poling the final molded article to align the electrical dipoles within the piezoelectric material; and forming a coating of conductive material over the top and bottom surfaces of the final molded article.

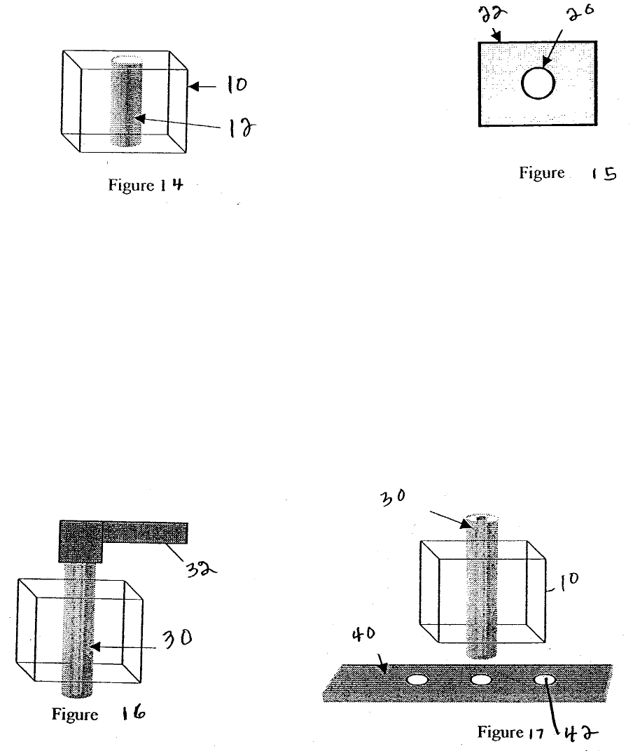

As shown in FIG. 14, a block 10 of ferroelectric material, preferably a piezoelectric material and preferably lead zirconate titinate (PbZrTiO₃) is formed to create a geometry with cylindrical voids 12. A first electrode 20 (FIG. 15) covers void 12 and a second electrode 22 covers block 10. The poling process is done such that when a voltage is applied between electrodes 20,22, a radial force is created at the cylindrical void 12. As shown in FIG. 16, each void contains a glass or plastic capillary 30 that is held in place with suitable cement. Examples of glass capillaries suitable for this application are available from Nippon Electric Glass, Inc. Capillary inside diameters on the order of 30-100 um and preferably in the range of 30-60 um are appropriate. The aforementioned radial force acts on the tube, which contains the molecular biological liquids, ejecting a drop of known volume. The molecular biological or chemical liquids are connected to the glass capillaries via suitable flexible or rigid tubing 32. A variant of this embodiment is shown in FIG. 17 includes an orifice plate 40 having orifices 42 that would cover the ends of the glass capillary(s).

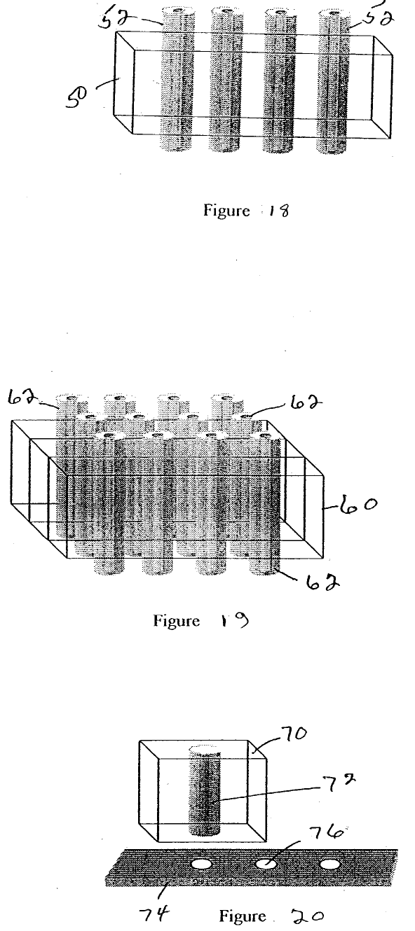

In yet another variant of this embodiment shown in FIG. 18, the piezoelectric element contains a linear array of 1×N capillary elements 52.

Yet another embodiment shown in FIG. 19, the piezoelectric element 60 contains an M×N array of capillary elements 62.

In another embodiment of this invention shown in FIG. 20, a block of ferroelectric material 70, preferably a piezoelectric material and preferably lead zirconate titinate (PbZrTiO₃) is formed to create a molded geometry with cylindrical voids 72 where each void is the channel for containing molecular biological and chemical liquids. An orifice plate 74 with apertures 76 covers the end of the molded channels. The shape of the voids could be geometries other than circular such as square or rectangular.

An electric signal is applied to the electrodes (See FIG. 2) to produce the necessary force to produce the ejection of a drop of liquid.

A system for producing a receiver (support) containing bio-specific solutions is described with reference to FIGS. 1-13. The system contains a printing station 90 1 or more “Net-Shaped” page-width printheads 100-108, a fluid delivery system 110, 112, printhead service/maintenance station and a receiver transport mechanism 116 and printhead translation mechanism 118. Computer 111 controls mechanisms 116,118, fluid deposition 110,112 and maintenance and service station 114. Approximately 1000 molecular biological liquids need to be uniquely placed on a 2-D grid, each solution occupying approximately 50-500 micro meter (um) diameter spot and preferably 50-200 um spot diameter. This invention is advantaged in that it provides for an efficient means to effectively produce arrays of biomolecules on a support, a means to easily remove printheads in the event they require service and a means for high-throughput array generation.

Specifically, a system is provided where bio-specific solutions can be efficiently placed at known locations. In one embodiment of this invention, a “Net-Shaped” page-width print head bar is described wherein the spacing of the bio-specific solutions on the support are matched equally to the spacing of the printhead nozzles. In addition, a system where the printhead nozzles are not equally spaced with respect to the dots formed on the support envisioned and is accomplished by the combination of printhead and receiver motion that is coupled to provide the desired dot spacing.

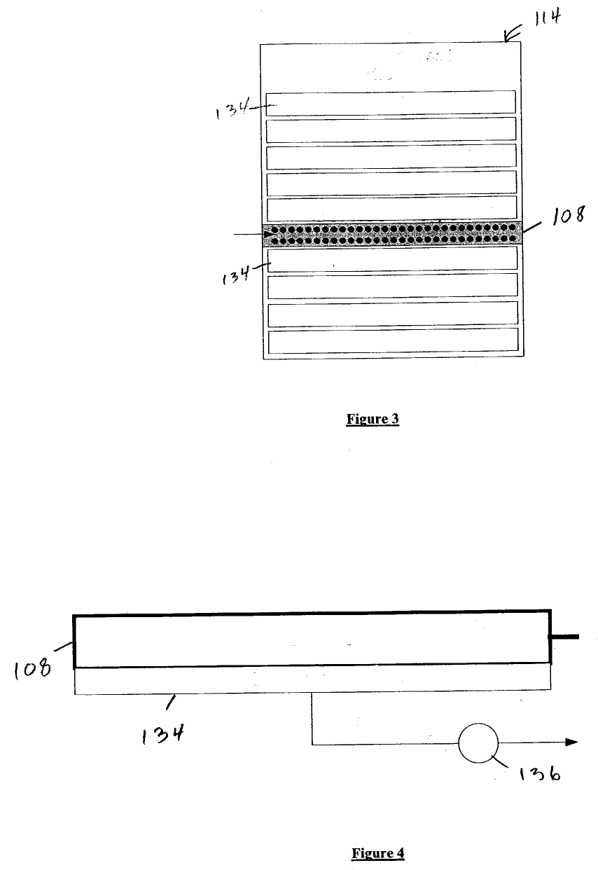

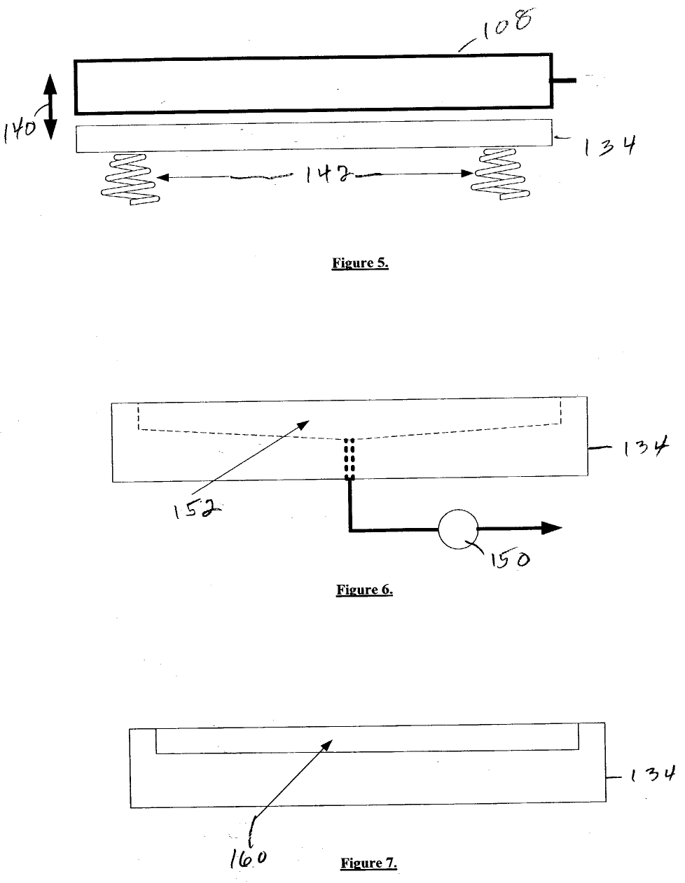

The printing or deposition of these sites would be created in the Printing Station 90 as shown in FIG. 1. The advantage of the system described in this application and shown in FIG. 1 is the ability to move the printheads in a direction 120 normal to the direction 122 of printing. This permits 2 features: 1) the ability to create unique patterns of bio-specific sites, and 2) the ability to move the “Net-shaped” printhead (shown in FIG. 2) to a Maintenance and Service Station 114 with maintenance elements as described in FIG. 3 and shown in detail in FIG. 4 and more specifically in FIG. 5 where the printhead motion relative to the maintenance element is shown. FIG. 2 shows printhead 100 as including two rows of nozzles 130 supplied by fluid line 132. FIG. 3 shows maintenance and service station 114 includes maintenance elements 134 aligned with print heads 100-108, etc. Printhead 108 is shown being maintained by maintenance element 134 in FIG. 4. Element 134 is shown as fluid cleaning system for printhead 108 including fluid source 136. In this station, the printhead can be serviced through various means such as the ability to cap the printhead with an appropriate capping means that will prevent the printheads from drying out during non-printing cycles. This station may also contain appropriate means such as controlled vacuum 150 linked to recess 152 to prime the printhead with bio-specific fluids (shown in FIG. 6) or the ability to jet into an element 134 that contains an absorbing material 160 as shown in FIG. 7.

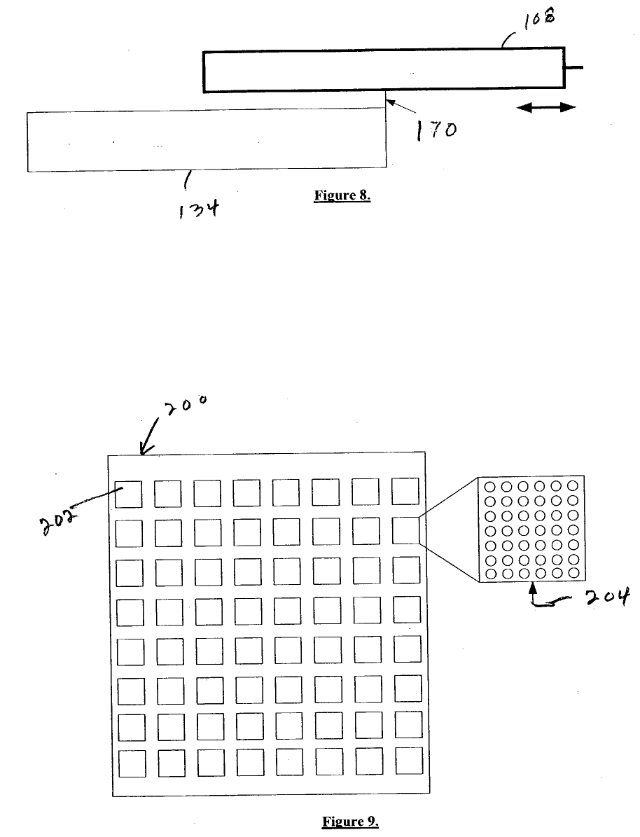

In addition, a maintenance element 134 is shown in FIG. 8 wherein said element contains a flexible wiping member 108 in which the motion of the printhead 108 relative to said wiping member 170 maintains the surface of the printhead 108 free of fluids and dirt.

The printheads 100-108 (or support) will move relative to each other to create the required deposition pattern, which could include but not limited to a uniform distribution of bio-specific sites, or groupings 202 of bio-specific sites that might repeat across the surface defined by the support. FIG. 9 shows a pattern in which groupings or sub-regions of the array 200 are arranged into a pattern of sub-arrays. This sub-array pattern is preferably contains 10 unique bio-specific fluids, more preferably contains 100 unique bio-specific fluids, and most preferably contains 1000 unique bio-specific fluids.

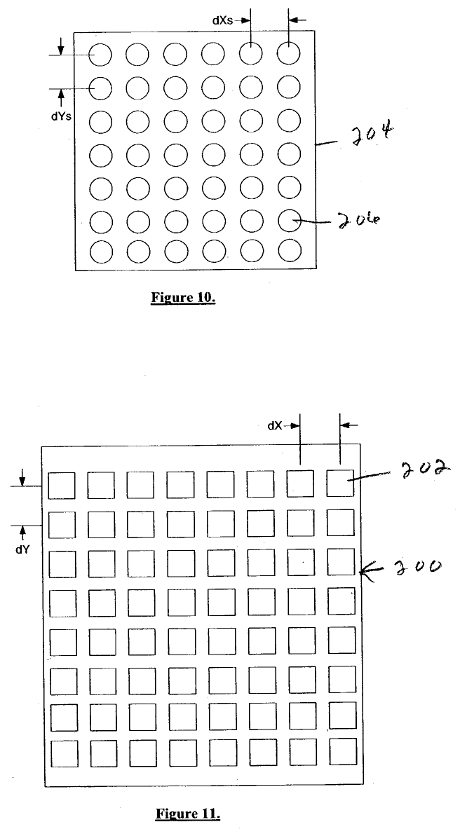

As shown in FIG. 10, the spacing of the bio-specific fluid spots 206 in the sub-array 204 preferably has a dot spacing (dXs, dYs) of 3000 um, more preferably of 1000 um, and most preferably of 300 um. Additionally, as shown in FIG. 1, the groupings of bio-specific sites (sub-arrays) 202 are most preferably arranged with a spacing (dX, dY) of 1 cm.

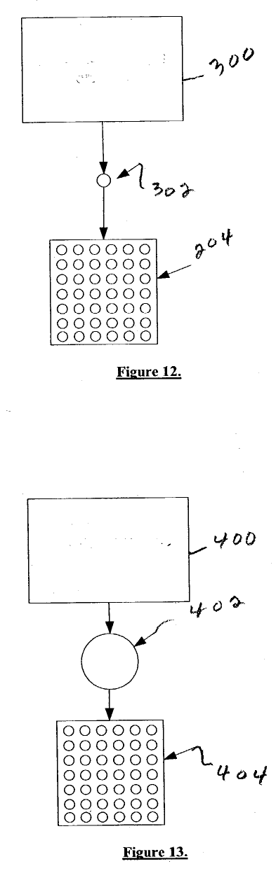

The printheads in the system can produce droplet sizes that are commensurate with the dot sizes as mentioned above. Specifically, as shown in FIG. 12, a bio-specific fluid droplet 402 of appropriate volume shall be produced by printhead 300 to create the sub-array. The volume of the droplet can be determined by first characterizing the fluid spread on the receiving layer as defined by the Spread Factor,

Spread Factor=SF=Dot dia/Drop dia

Once this has been determined, then the appropriate drop volume can be calculated (assuming a spherical drop relationship),

Vol=(4π/3)*R³=(4π/3)*((Dot Dia)/(2SF))³

where R is the radius of the drop.

Assuming a Spread Factor of 2, then preferably, this volume to produce the sub-array shall be 200 nL, or more preferably 7.5 nL, and most preferably 200 pL micro-droplets.

FIG. 13 shows a printhead 400 for large droplets 402 that can cover the entire sub-array 404 with a single fluid.

The device can have printheads that can produce micro droplet volumes that are appropriate for generating sub-arrays as well as ones that can produce macro-droplet volumes for covering the sub-array fluids with yet another fluid, which will increase the bio-diversity of the array. In practice, it is envisioned that an array is initially created, with 1000 unique bio-specific fluids in an N×M pattern. This is defined as a sub-array as shown in FIG. 9. The printhead that generates this sub-array is capable of generating micro-droplets. It is further envisioned that another printhead, capable of producing macro-droplets, will further increase the bio-diversity or search capabilities of the array by placing a droplet that covers the entire sub-array region, as thus interacts with the entire unique bio-fluids contained in this N×M sub-array.

The invention has been described in detail with particular reference to certain preferred embodiments thereof, but it will be understood that variations and modifications can be effected within the spirit and scope of the invention.

### Parts List

block of ferroelectric material

10 cylindrical void

12 electrodes

20,22 glass or plastic capillary

30 flexible or rigid tubing

32 orifice plate

40 orifices

42 piezelectric element

50 capillary elements

52 piezelectric element

60 capillary elements

62 ferroelectric material

70 cylindrical voids

74 orifice plate

76 apertures

90 printing station

100-108 page-width printhead

110 fluid delivery system

111 computer

112 fluid delivery system

114 service station

116-118 controls mechanism

120 printhead direction

122 printhead direction

130 nozzles

134 fluid cleaning system

136 fluid source

150 controlled vacuum

152 recess

160 absorbing material

170 wiping member

200 array

202 groups of bio-specific sites

204 sub-array

206 bio-specific fluid spots

300 printhead

402 bio-specific fluid droplet

404 entire sub-array

What is claimed is:

1. A system for depositing molecular liquids on a receiver comprising:
a printing station having one or more print heads spanning the width of a receiver to be printed on;
a receiver transport mechanism for transporting a receiver through said printing station so that said one or more print heads can deposit molecular liquids in an array on said receiver;
a maintenance and service station located in proximity to said printing station; and
a printhead translation mechanism for moving a printhead to said maintenance and service station to receive maintenance and service.

2. The system of claim 1 wherein said one or more printheads are positioned in proximity to eachother in said printing station and wherein said maintenance and service station includes a maintenance element for each said printhead.

3. The system of claim 2 wherein each said maintenance element is located proximal to its corresponding printhead and wherein said printhead translation mechanism translates a printhead from said printing station to said maintenance and service station and into engagement with said maintenance element.

4. The system of claim 3 wherein said printhead translation mechanism moves a printhead between said stations in a direction perpendicular to the direction of movement of a receiver past said printheads.

5. The system of claim 4 wherein said maintenance elements are spring biased into engagement with a corresponding printhead moved to said maintenance and service station.

6. The system of claim 1 wherein said maintenance and service station carries out one or more of the following operations on a printhead;
wiping the printhead free of fluids;
vacuuming the printhead of excess fluids;
capping the printhead to prevent the printhead from drying out;
priming the printhead with fluid.

7. The system of claim 1 wherein each said printhead includes a block of piezelectric material having a plurality of voids passing through said block; and
first and second electrodes respectively coating said void and said block, such that application of a voltage between said electrodes produces a radial force to constrict said void and eject liquid contained in said void.

8. The system of claim 1 wherein in a first pass through said printing station said printheads deposit an array of subarrays of different molecular liquids and in a second pass through said printing station said printheads deposit a single molecular liquid over each subarray.
